(19) United States
(12) Patent Application Publication
(10) Pub. No.: US 2026/0024260 A1
(43) Pub. Date: Jan. 22, 2026

(54) MOVEMENT TRAJECTORY PLAYBACK METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Xiao SUN, Shenzhen (CN)

(21) Appl. No.: 19/343,987

(22) Filed: Sep. 29, 2025

Related U.S. Application Data
(63) Continuation of application No. PCT/CN2024/105472, filed on Jul. 15, 2024.

(30) Foreign Application Priority Data
Sep. 25, 2023 (CN) 202311244383.2

(51) Int. Cl. G06T 13/20; G06T 7/20; G06T 15/20

(52) U.S. Cl. CPC G06T 13/20; G06T 7/20; G06T 15/20; G06T 2207/30241; G06T 2210/21

(57) ABSTRACT

A movement trajectory playback method performed by an electronic device includes obtaining a three-dimensional virtual scene, determining a real movement trajectory of a real object, mapping the real movement trajectory to the three-dimensional virtual scene to obtain a virtual movement trajectory, setting, in the three-dimensional virtual scene, a virtual object corresponding to the real object and a virtual lens corresponding to the virtual object with a preset relative positional relationship between the virtual lens and the virtual object being maintained, controlling the virtual object to move along the virtual movement trajectory, controlling the virtual lens to capture an image of the virtual object moving along the virtual movement trajectory, and displaying the image.

### CROSS-REFERENCE OT RELATED APPLICATIONS

This application is a continuation of International Application No. PCT/CN2024/105472, filed on Jul. 15, 2024, which claims priority to Chinese Patent Application No. 2023112443832, entitled “MOVEMENT TRAJECTORY PLAYBACK METHOD AND APPARATUS, ELECTRONIC DEVICE, AND STORAGE MEDIUM” filed on Sep. 25, 2023, the entire contents of both of which are incorporated herein by reference.

### FIELD OF THE TECHNOLOGY

This application relates to electronic map data processing technologies, and in particular, to a movement trajectory playback method and apparatus, an electronic device, and a storage medium.

### BACKGROUND OF THE DISCLOSURE

With the development and popularization of sensor technology, positioning using Global Navigation Satellite System (GNSS) has become a fundamental capability of terminal devices, such as automobiles, mobile phones, and watches. After utilizing GNSS to complete user trajectory recording, the relevant devices or application programs can provide dynamic trajectory playback.

Movement trajectory playback refers to continuously updating the user trajectory and the map status of the display area at appropriate time intervals until the end of the user trajectory.

However, the current movement trajectory playback typically presents the movement of the target object on a simple map interface and cannot accurately reconstruct the navigation scenarios encountered by users during real-world actions.

### SUMMARY

In accordance with the disclosure, there is provided a movement trajectory playback method performed by an electronic device and including obtaining a three-dimensional virtual scene, determining a real movement trajectory of a real object, mapping the real movement trajectory to the three-dimensional virtual scene to obtain a virtual movement trajectory, setting, in the three-dimensional virtual scene, a virtual object corresponding to the real object and a virtual lens corresponding to the virtual object with a preset relative positional relationship between the virtual lens and the virtual object being maintained, controlling the virtual object to move along the virtual movement trajectory, controlling the virtual lens to capture an image of the virtual object moving along the virtual movement trajectory, and displaying the image.

Also in accordance with the disclosure, there is provided an electronic device including a processor and a memory storing a plurality of instructions that, when executed by the processor, cause the electronic device to obtain a three-dimensional virtual scene, determine a real movement trajectory of a real object, map the real movement trajectory to the three-dimensional virtual scene to obtain a virtual movement trajectory, set, in the three-dimensional virtual scene, a virtual object corresponding to the real object and a virtual lens corresponding to the virtual object with a preset relative positional relationship between the virtual lens and the virtual object being maintained, control the virtual object to move along the virtual movement trajectory, control the virtual lens to capture an image of the virtual object moving along the virtual movement trajectory, and display the image.

Also in accordance with the disclosure, there is provided a non-transitory computer-readable storage medium storing a plurality of instructions stored that, when executed by a processor, cause an electronic device including the processor to obtain a three-dimensional virtual scene, determine a real movement trajectory of a real object, map the real movement trajectory to the three-dimensional virtual scene to obtain a virtual movement trajectory, set, in the three-dimensional virtual scene, a virtual object corresponding to the real object and a virtual lens corresponding to the virtual object with a preset relative positional relationship between the virtual lens and the virtual object being maintained, control the virtual object to move along the virtual movement trajectory, control the virtual lens to capture an image of the virtual object moving along the virtual movement trajectory, and display the image.

### BRIEF DESCRIPTION OF THE DRAWINGS

To more clearly illustrate technical solutions in embodiments of this application, the drawings for the description of the embodiments are briefly introduced below. It is apparent that the drawings in the following description are merely the embodiments of this application. A person of ordinary skill in the art may, without any inventive effort, obtain other drawings according to the disclosed drawings.

FIG. 1 is a schematic diagram showing a scenario of a movement trajectory playback method according to an embodiment of this application.

FIG. 2 is a schematic flow chart of a movement trajectory playback method according to an embodiment of this application.

FIG. 3 is a schematic diagram showing a relative positional relationship between a vehicle and a virtual lens in a side view of the vehicle according to an embodiment of this application.

FIG. 4 is a schematic diagram showing a relative positional relationship between a virtual lens and a vehicle in a rear view of the vehicle according to an embodiment of this application.

FIG. 5 is a schematic diagram showing a pitch angle range of a virtual lens according to an embodiment of this application.

FIG. 6 is a schematic diagram showing a lens movement segment of a virtual object during intersection entry according to an embodiment of this application.

FIG. 7 is a schematic flow diagram showing the application of a movement trajectory playback method in an electronic device according to an embodiment of this application.

FIG. 8 is a schematic flow chart of a method for obtaining driving data according to an embodiment of this application.

FIG. 9 is a specific implementation flowchart of an electronic device performing movement trajectory playback according to an embodiment of this application.

FIG. 10 is a playback image of a first segment of a trajectory to be played back according to an embodiment of this application.

FIG. 11 is a playback image of a second segment of a trajectory to be played back according to an embodiment of this application.

FIG. 12 is a playback image of a third segment of a trajectory to be played back according to an embodiment of this application.

FIG. 13 is a playback image of a fourth segment of a trajectory to be played back according to an embodiment of this application.

FIG. 14 is a playback image of a vehicle passing through an intersection according to an embodiment of this application.

FIG. 15 is a playback image of a vehicle turning at an intersection according to an embodiment of this application.

FIG. 16 is a playback image of a vehicle approaching a special building according to an embodiment of this application.

FIG. 17 is a playback image of a vehicle passing by a special building according to an embodiment of this application.

FIG. 18 is a playback image of a vehicle after passing a special building according to an embodiment of this application.

FIG. 19 is a schematic structural diagram of a movement trajectory playback apparatus according to an embodiment of this application.

FIG. 20 is a schematic structural diagram of an electronic device according to an embodiment of this application.

### DESCRIPTION OF EMBODIMENTS

Technical solutions in embodiments of this application are described below with reference to the drawings in the embodiments of this application. It is apparent that the described embodiments are merely part of rather than all of the embodiments of this application. All other embodiments obtained by a person of ordinary skill in the art based on the embodiments of this application, without any inventive effort, fall within the scope of protection of this application.

The embodiments of this application provide a movement trajectory playback method and apparatus, an electronic device, and a storage medium.

The movement trajectory playback apparatus can be specifically integrated into an electronic device, which may be a terminal, a server, or the like. The terminal may be an onboard terminal, an intelligent voice interaction device, a mobile phone, a tablet computer, a smart Bluetooth device, a laptop, a personal computer (PC), or the like. The server may be a single server or a server cluster including a plurality of servers.

In some embodiments, the movement trajectory playback apparatus may further be integrated into a plurality of electronic devices. For example, the movement trajectory playback apparatus may be integrated into a plurality of servers, and the movement trajectory playback method of this application may be implemented by the plurality of servers. In some embodiments, the terminal may further be used as a server to perform part or all of the functions of the server.

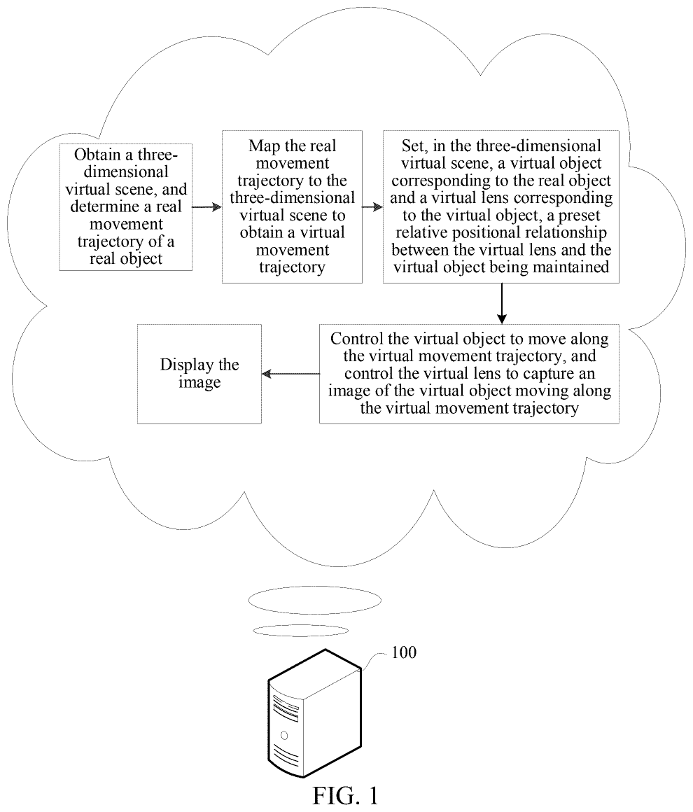

For example, referring to FIG. 1, the electronic device 100 may perform the following operations: obtaining a three-dimensional virtual scene, and determining a real movement trajectory of a real object; mapping the real movement trajectory to the three-dimensional virtual scene to obtain a virtual movement trajectory; setting, in the three-dimensional virtual scene, a virtual object corresponding to the real object and a virtual lens corresponding to the virtual object, a preset relative positional relationship between the virtual lens and the virtual object being maintained; controlling the virtual object to move along the virtual movement trajectory, and controlling the virtual lens to capture an image of the virtual object moving along the virtual movement trajectory; and displaying the image.

In specific implementations of this application, related data such as driving data, positioning information, and position information are involved. When the following embodiments of this application are applied to specific products or technologies, permissions or consent are required, and the collection, use, and processing of relevant data need to comply with the applicable laws, regulations, and standards of relevant countries and regions.

The following will be described in detail. The sequence numbers of the following embodiments are not intended to limit the preferred order of the embodiments.

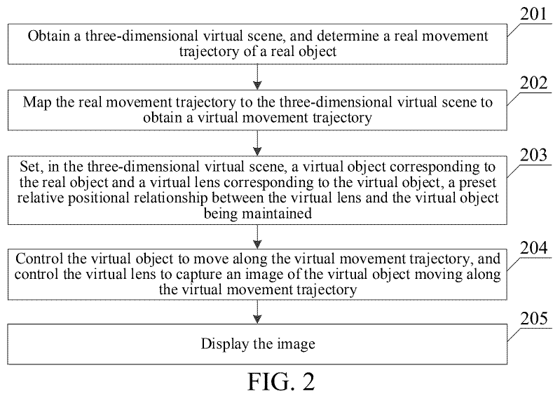

In this embodiment, a movement trajectory playback method related to map navigation is provided. As shown in FIG. 2, a specific flow of the movement trajectory playback method may be as follows:

201: Obtain a three-dimensional virtual scene, and determine a real movement trajectory of a real object.

The three-dimensional virtual scene refers to a virtual environment with a sense of depth and realism, generated by computer technology and graphics algorithms. This virtual environment may be a simulated scene from the real world or an imagined fictional scene. In this embodiment, the three-dimensional virtual scene may be a scene simulated based on a geographic map of the real world. In the three-dimensional virtual scene, elements such as terrain, topography, buildings, and roads on the Earth's surface can be presented in a three-dimensional manner. In the three-dimensional virtual scene, a user can observe different regions and terrain features by rotating, zooming, and panning the viewing perspective, thereby gaining a better understanding of the Earth's geographical environment. The three-dimensional virtual scene can be constructed based on data such as satellite remote sensing data, topographic survey data, and building data. These data are integrated into a geographic information system and rendered using three-dimensional visualization technology to obtain the three-dimensional virtual scene.

The real object may be an object existing in the real world whose real movement trajectory needs to be played back. In this embodiment, the real object may be a self-mobile object. The real object can also carry a positioning device or be equipped with a positioning system to record the real movement trajectory. For example, the real object may include, but is not limited to, vehicles, mobile terminals, aircraft, trains, ships, and mobile robots.

The real movement trajectory can be determined using driving data, which refers to various data generated by the real object during the movement. For example, the driving data includes, but is not limited to, real movement trajectory data, movement speed, acceleration, timestamps, mileage, and weather information. As an example, in an example of a vehicle, the driving data can be collected through onboard sensors, the Global Positioning System (GPS), onboard devices, mobile applications, or the like. The real movement trajectory data refers to data that records the real movement trajectory, which may include discrete points along the real movement trajectory or parameters of a mathematical expression representing or fitting the real movement trajectory.

The real movement trajectory refers to the route path traveled by the real object in the real world over a period of time. It records the position coordinates of the real object at different moments (hereinafter also referred to as position points), forming a trajectory data set. In an example of a vehicle, the real movement trajectory can be recorded and obtained in real time through onboard devices, GPS, mobile devices, or the like. Each position point may include information such as longitude, latitude, altitude, and timestamp. By connecting these position points in chronological order, the real movement trajectory of the vehicle over a period of time can be reconstructed.

In some implementations, the data configured for rendering the three-dimensional virtual scene and the driving data of the real object may be pre-collected and stored locally in the electronic device, or stored in a cloud server in communication with the electronic device. When the movement trajectory playback is required, the electronic device may retrieve data configured for rendering the three-dimensional virtual scene and the driving data from a local or cloud server. After rendering the data configured for rendering the three-dimensional virtual scene, the three-dimensional virtual scene can be obtained.

202: Map the real movement trajectory to the three-dimensional virtual scene to obtain a virtual movement trajectory.

A specific implementation of mapping the real movement trajectory to the three-dimensional virtual scene may include: matching each position coordinate in the trajectory data with a corresponding position in the three-dimensional virtual scene to obtain a mapped coordinate corresponding to each of the above position coordinates in the three-dimensional virtual scene, and then drawing, based on the obtained mapped coordinates, the virtual movement trajectory in the three-dimensional virtual scene.

Since the three-dimensional virtual scene is proportionally constructed based on the real world, each position point in the movement trajectory obtained from the real world can be matched to a corresponding position in the three-dimensional virtual scene.

In some implementations, before the mapping the real movement trajectory to the three-dimensional virtual scene to obtain a virtual movement trajectory, the movement trajectory may be preprocessed. The preprocessing may include removing outliers, smoothing the trajectory, transforming coordinate systems, and the like, thereby ensuring the accuracy and stability of the data.

203: Set, in the three-dimensional virtual scene, a virtual object corresponding to the real object and a virtual lens corresponding to the virtual object, a preset relative positional relationship between the virtual lens and the virtual object being maintained.

The virtual lens may refer to a virtual camera. In the three-dimensional virtual scene, the virtual lens is configured to simulate the viewing perspective of a human eye or a camera. By adjusting the position, orientation, field of view, and other properties of the virtual lens, different viewing effects and perspectives can be achieved. In some embodiments, the virtual lens setting options may include the pitch angle, orientation, position, and the like of the virtual lens.

In some implementations, the virtual object may be constructed according to the information of the real object. For example, the attributes of the virtual object, such as color, texture, shape, and size, may be adjusted according to the appearance and features of the real object, so as to more closely resemble the real object. In some embodiments, a specific image marker may be set in the three-dimensional virtual scene to represent the real object, such as an oriented image marker.

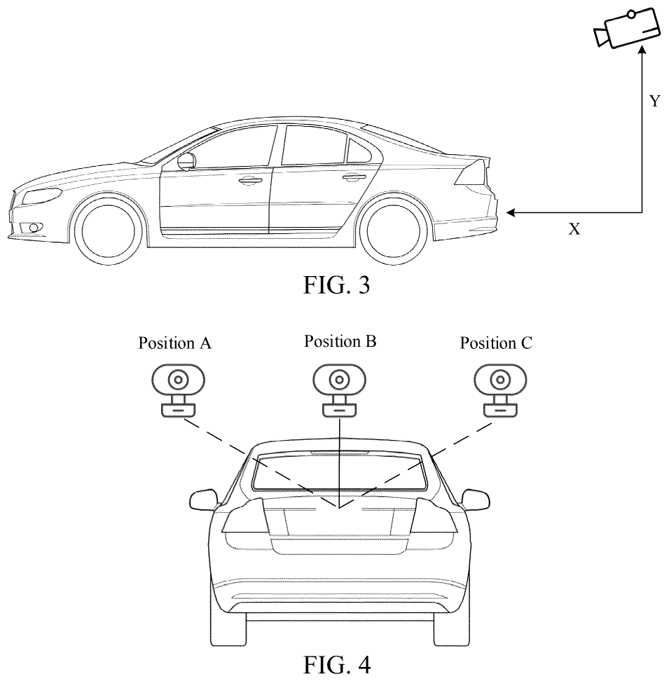

The preset relative positional relationship between the virtual lens and the virtual object may be maintained. The preset relative positional relationship may be that the virtual lens is located above and behind the virtual object, thereby allowing the virtual lens to capture images of the virtual object as well as images along the movement direction of the virtual object. Exemplarily, in an example where the virtual object is a virtual vehicle, as shown in FIG. 3, FIG. 3 shows a relative positional relationship between the vehicle and the virtual lens in a side view of the vehicle. In the side view of the vehicle, the virtual lens may be located above and behind the vehicle, the horizontal distance between the virtual lens and the rear end of the vehicle may be X, and the vertical distance between the virtual lens and the rear end of the vehicle may be Y. In some embodiments, the values of X and Y may be custom-set according to actual requirements, which are not limited thereto.

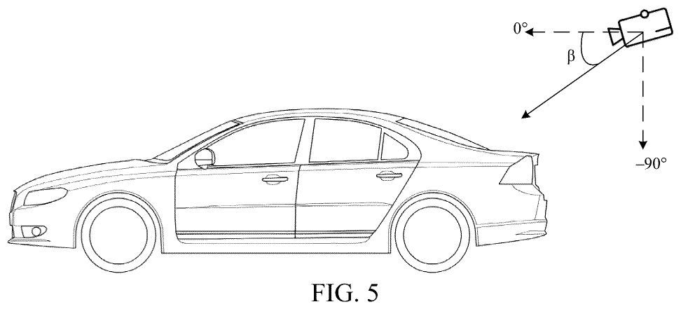

In some embodiments, as shown in FIG. 4, FIG. 4 shows a relative positional relationship between the virtual lens and the vehicle in a rear view of the vehicle. In the rear view of the vehicle, the virtual lens may be located at the center of the vehicle (e.g., position B in FIG. 4). In addition, the virtual lens may be located at the left side of the vehicle (e.g., position A in FIG. 4) or at the right side of the vehicle (e.g., position C in FIG. 4), which is not limited thereto.

During the movement of the virtual object, the preset relative positional relationship between the virtual lens and the virtual object is maintained. In other words, as the virtual object moves, the virtual lens moves along with the virtual object, and the relative positional relationship between the virtual lens and the virtual object remains unchanged throughout the movement.

204: Control the virtual object to move along the virtual movement trajectory, and control the virtual lens to capture an image of the virtual object moving along the virtual movement trajectory.

In operation 204, the controlling the virtual object to move along the virtual movement trajectory, and controlling the virtual lens to capture an image of the virtual object moving along the virtual movement trajectory includes:

S1: Obtain position information of the virtual object on the virtual movement trajectory.

The position information may be the position coordinate of the virtual object's current position on the virtual movement trajectory. The position coordinate may be represented by longitude and latitude. Since the virtual movement trajectory is formed by connecting a plurality of position points, in some implementations, it may be detected which of the plurality of position points on the virtual movement trajectory corresponds to the current position of the virtual object, and the position coordinate of the matching position point is then used as the current position information of the virtual object. As an example, the position information of the virtual object may be compared with the plurality of position points on the virtual movement trajectory to identify the position point closest to the position information, which is then used as the matching position point.

S2: Based on the position information, control the virtual object to move along the virtual movement trajectory, and control the virtual lens to capture the image of the virtual object moving along the virtual movement trajectory.

In operation S2, a specific implementation of controlling, based on the position information, the virtual object to move along the virtual movement trajectory may include:
A1: Determine, according to the position information, a remaining trajectory length of the virtual object, the remaining trajectory length being a length of the portion of the virtual movement trajectory that the virtual object has not traversed.

After the position information of the virtual object is determined, a position point on the virtual movement trajectory that matches the position information may be identified. Then, the plurality of position points from the matching position point to the end point of the virtual movement trajectory may be sequentially traversed in the virtual movement trajectory to obtain the remaining trajectory. Based on the position coordinates of each of the plurality of position points from the matching position point to the end point of the virtual movement trajectory, distance calculations may be performed to obtain the remaining trajectory length.
A2: Determine, according to the remaining trajectory length, a target movement speed of the virtual object, the target movement speed being negatively correlated with the remaining trajectory length.

The target movement speed may be a movement speed that the virtual object is required to maintain when moving in the three-dimensional virtual scene.

Since the movement trajectory playback process also represents the movement process of the virtual object in the three-dimensional virtual scene, the movement speed of the virtual object may correspond to the playback speed of the movement trajectory playback. The faster the movement speed, the faster the playback speed of the movement trajectory playback.

In some implementations, the current movement speed of the virtual object may be increased as the remaining trajectory length decreases, thereby obtaining the target movement speed. In some embodiments, each time the remaining trajectory length decreases by a preset length, the movement speed of the virtual object may be increased by a preset speed over the current speed, thereby obtaining the target movement speed.
A3: Control, based on the target movement speed, the virtual object to move along the virtual movement trajectory.

As an example, after the target movement speed is determined, the virtual object may be controlled to move along the virtual movement trajectory at the target movement speed.

In this implementation, by determining, according to the remaining trajectory length, a target movement speed of the virtual object, where the target movement speed is negatively correlated with the remaining trajectory length, and controlling, based on the target movement speed, the virtual object to move along the virtual movement trajectory, the movement speed of the virtual object increases as it approaches the end point of the virtual movement trajectory, i.e., the playback speed becomes faster, avoiding visual fatigue for the user.

In operation S2, a specific implementation of controlling, based on the position information, the virtual object to move along the virtual movement trajectory may further include:

According to the remaining trajectory length, a target virtual lens angle of the virtual lens is determined, where the target virtual lens angle is positively correlated with the remaining trajectory length, the target virtual lens angle being a pitch angle of the virtual lens, and the target virtual lens angle ranging from −90 degrees to 0 degrees.

As shown in FIG. 5, the pitch angle of the virtual lens may be β, where −90°≤B≤0°. As shown in FIG. 5, when the pitch angle β of the virtual lens decreases, the image captured by the virtual lens approaches a top-down view of the vehicle, and in this case, the objects in the three-dimensional virtual scene appear simpler. When the pitch angle β of the virtual lens increases, the image captured by the virtual lens approaches a horizontal view of the vehicle, and in this case, the objects appear more detailed, enabling the user to experience the real scene during the movement trajectory playback in a more immersive manner.

In some implementations, the current pitch angle corresponding to the virtual lens may be reduced as the remaining trajectory length decreases, thereby obtaining a target pitch angle.

Based on the target virtual lens angle, the virtual lens is controlled to capture the image of the virtual object moving along the virtual movement trajectory.

As an example, after the target virtual lens angle is determined, the current pitch angle of the virtual lens may be adjusted to the target virtual lens angle, and the virtual lens may then be controlled to capture the image of the virtual object moving along the virtual movement trajectory.

In this implementation, as the movement trajectory playback approaches the end, the pitch angle of the virtual lens is adjusted to be smaller, so that the image captured by the virtual lens can gradually transition from a detailed display to a simplified display, avoiding visual fatigue for the user.

In operation S2, a specific implementation of controlling, based on the position information, the virtual lens to capture the image of the virtual object moving along the virtual movement trajectory may further include:

According to the remaining trajectory length, a target map scale corresponding to the virtual lens is determined, the target map scale being positively correlated with the remaining trajectory length.

The map scale refers to the ratio of the length of a line segment on the map to the length of the corresponding line segment on the ground after horizontal projection. It represents the degree of reduction of the map graphics and is also referred to as the reduction scale. Generally, the larger the map scale, the smaller the error and the higher the measurement accuracy on the map.

Based on the target map scale, the virtual lens is controlled to capture the image of the virtual object moving along the virtual movement trajectory.

In some implementations, the current map scale corresponding to the virtual lens may be reduced as the remaining trajectory length decreases, thereby obtaining the target map scale.

As an example, after the target map scale is determined, the current map scale corresponding to the virtual lens may be adjusted to the target map scale by adjusting the focal length of the virtual lens, and the virtual lens may then be controlled to capture the image of the virtual object moving along the virtual movement trajectory.

The smaller the focal length, the wider the field of view and the larger the capture range; more of the image can be captured, but each object occupies a smaller proportion of the image. The larger the focal length, the narrower the field of view and the smaller the capture range; less of the image can be captured, but each object occupies a larger proportion of the image.

In this implementation, as the movement trajectory playback approaches the end, the map scale corresponding to the virtual lens is adjusted to be smaller, so that the image captured by the virtual lens can gradually expand in the field of view, avoiding visual fatigue for the user.

In some implementations, the movement speed of the virtual object, the pitch angle of the virtual lens, and the map scale corresponding to the virtual lens are simultaneously controlled according to the remaining trajectory length. During the movement trajectory playback, as the remaining trajectory length decreases, the virtual object increases the movement speed. Therefore, when the remaining trajectory length decreases, simultaneously reducing the pitch angle and the map scale allows the image captured by the virtual lens to better match the movement speed for display, preventing the user from experiencing dizziness when continuously viewing an image with a narrow field of view and a large pitch angle at higher playback speeds.

In some implementations, the virtual movement trajectory includes a plurality of control nodes. In operation S2, a specific implementation of based on the position information, controlling the virtual object to move along the virtual movement trajectory, and controlling the virtual lens to capture the image of the virtual object moving along the virtual movement trajectory may include: When it is determined, according to the position information, that the virtual object has arrived at a control node, a control strategy corresponding to the control node is obtained.

The control nodes may be position points pre-marked on the virtual movement trajectory, so the control nodes can also be represented by longitude and latitude. Exemplarily, the position where the real object encounters a special event may be marked on the real movement trajectory of the real world, and the position may then be mapped to the virtual movement trajectory to obtain the control node. In some embodiments, the special events include arriving at an intersection, reaching a specified building, entering a designated road segment, and the like. The special events can be custom-set according to actual requirements, which are not limited thereto. For each special event, a set of control strategies may be pre-established, and the control strategies corresponding to the special event may be bound to the control nodes corresponding to the event, thereby establishing associations between a plurality of control nodes and a plurality of control strategies.

Based on the control strategy corresponding to the control node, the virtual object is controlled to move along the virtual movement trajectory, and the virtual lens is controlled to capture the image of the virtual object moving along the virtual movement trajectory.

The based on the control strategy corresponding to the control node, controlling the virtual object to move along the virtual movement trajectory, and controlling the virtual lens to capture the image of the virtual object moving along the virtual movement trajectory includes:
B1: Obtain a type of the control node.

Each control node may carry a type label for representing the type of the control node. The type of each control node can be determined by identifying the type label of the control node. In some embodiments, the type of the control node may include a normal control node, a lens movement control node, and the like. The lens movement control node may refer to a node on the virtual movement trajectory where a lens movement operation is required, whereas the normal control node may refer to a node on the virtual movement trajectory where no lens movement operation is required (for example, the lens orientation corresponding to the normal control node is fixed toward the route direction of the virtual object's movement path). The lens movement control node may include a lens movement start node and a lens movement end node. When the virtual object reaches the lens movement start node, the lens movement operation is started, and when the virtual object reaches the lens movement end node, the lens movement operation is ended.

The lens movement operation may refer to an operation of adjusting the lens orientation, for example, gradually adjusting the lens orientation from facing the virtual object to facing a building in the three-dimensional virtual scene.
B2: When the control node is a normal control node, obtain control parameters corresponding to the normal control node, the control parameters including a movement speed of the virtual object, a virtual lens angle of the virtual lens, and a map scale corresponding to the virtual lens, the virtual lens angle being a pitch angle of the virtual lens, and the virtual lens angle ranging from −90 degrees to 0 degrees.

A plurality of normal control nodes may be provided, and each normal control node in the plurality of normal control nodes may be pre-bound to a set of control parameters. Exemplarily, the control parameters, as well as the mapping relationship between the control parameters and the normal control nodes, may be pre-stored in a preset parameter database. Upon determining the normal control node currently reached by the virtual object, the control parameters corresponding to the normal control node may be retrieved from the preset parameter database.

In some implementations, the normal control node includes a first control node, a second control node, and a third control node, and the first control node, the second control node, and the third control node divide the virtual movement trajectory into a first sub-trajectory, a second sub-trajectory, a third sub-trajectory, and a fourth sub-trajectory. The first sub-trajectory is a trajectory between the first control node and a starting point of the virtual movement trajectory. The second sub-trajectory is a trajectory between the first control node and the second control node. The third sub-trajectory is a trajectory between the second control node and the third control node. The fourth sub-trajectory is a trajectory between the third control node and an end point of the virtual movement trajectory.

In some embodiments, a ratio of trajectory lengths of the first sub-trajectory, the second sub-trajectory, the third sub-trajectory, and the fourth sub-trajectory is 2:1:2:5.

The number of normal control nodes may not be limited to the three in the above embodiments, and may be other numbers, for example, two, four, and five, which is not limited thereto. Different numbers of normal control nodes may divide the virtual movement trajectory into the corresponding number of sub-trajectories. For example, two normal control nodes may divide the trajectory into three sub-trajectories, and five normal control nodes may divide the trajectory into six sub-trajectories. The ratios of the trajectory lengths of the plurality of divided sub-trajectories may be set according to actual requirements, which are not limited thereto.

In some implementations, control parameters corresponding to the first control node include a first movement speed, a first virtual lens angle, and a first map scale. Control parameters corresponding to the second control node include a second movement speed, a second virtual lens angle, and a second map scale. Control parameters corresponding to the third control node include a third movement speed, a third virtual lens angle, and a third map scale.

The first movement speed is less than the second movement speed, and the second movement speed is less than the third movement speed. The first virtual lens angle is greater than or equal to the second virtual lens angle, and the second virtual lens angle is greater than the third virtual lens angle. The first map scale is greater than the second map scale, and the second map scale is greater than the third map scale.

In some implementations, the starting point of the virtual movement trajectory corresponds to initial control parameters, where the initial control parameters include an initial movement speed, an initial virtual lens angle, and an initial map scale. The initial movement speed is less than or equal to the first movement speed, the initial virtual lens angle is greater than the first virtual lens angle, and the initial map scale is greater than the first map scale.

Exemplarily, in an example where a virtual movement trajectory represents a 50-kilometer real movement trajectory, the initial movement speed may be 500 m/s, the first movement speed may be 500 m/s, the second movement speed may be 2000 m/s, and the third movement speed may be 5000 m/s.

In some embodiments, the initial map scale may be 1:10, where a map scale of 1:10 may indicate that each unit length on the map represents 10 meters on the ground. The first map scale may be 1:20, the second map scale may be 1:50, and the third map scale may be 1:100.

In some embodiments, the initial virtual lens angle may be −10°, the first virtual lens angle may be −20°, the second virtual lens angle may be −30° or −20°, and the third virtual lens angle may be −90°.

When the virtual lens angle of the virtual lens is 90°, the image captured by the virtual lens corresponds to a top-down view of the three-dimensional virtual scene, that is, a two-dimensional planar image.

In some implementations, to ensure that the playback duration of each sub-trajectory falls within an appropriate range, a corresponding playback duration may be set for each sub-trajectory. For example, the playback duration of the first sub-trajectory may be set between 3 seconds and 12 seconds; the playback duration of the second sub-trajectory may be set between 2 seconds and 8 seconds; the playback duration of the third sub-trajectory may be set between 1 second and 5 seconds; the playback duration of the fourth sub-trajectory may be set to 1 second to 5 seconds.
B3: Control, based on the movement speed, the virtual object to move along the virtual movement trajectory.
B4: Control, based on the virtual lens angle and the map scale, the virtual lens to capture the image of the virtual object moving along the virtual movement trajectory.

In this implementation, by segmenting the virtual movement trajectory and controlling the captured images to provide a more immersive view at a relatively slow movement speed during the first half of the movement trajectory playback, the user's viewing experience can be enhanced. During the second half of the trajectory, by increasing the movement speed and capturing images with a larger field of view and simpler composition, visual fatigue for the user can be avoided.

In some implementations, the based on the control strategy corresponding to the control node, controlling the virtual object to move along the virtual movement trajectory, and controlling the virtual lens to capture the image of the virtual object moving along the virtual movement trajectory includes:
C1: Obtain a type of the control node.
C2: When the control node is a lens movement control node, determine a lens movement object corresponding to the lens movement control node.

The lens movement object may be an object in the three-dimensional virtual scene that has been pre-marked for lens movement operations. For example, the lens movement object may be a building, an intersection, a landmark, or the like in the three-dimensional virtual scene.

In some implementations, each lens movement control node may be pre-bound to a lens movement object. Therefore, after a lens movement control node is determined, the corresponding lens movement object may be selected according to the lens movement control node. Exemplarily, for example, when the vehicle navigates in the real world, the user may mark a building as the lens movement object in the navigation system upon passing the building. The navigation system may then automatically take the position point of the building in the real movement trajectory as a lens movement position point and map the lens movement position point to the three-dimensional virtual scene to obtain the lens movement control node. The building in the navigation system may be mapped to the three-dimensional virtual scene to obtain the lens movement object.
C3: Obtain a lens orientation corresponding to the lens movement object.

Different lens movement objects are pre-associated with different lens orientations. Therefore, after a lens movement object is determined, a lens orientation corresponding to the lens movement object may be selected from a plurality of preset lens orientations as the lens orientation.

As an implementation, the obtaining a lens orientation corresponding to the lens movement object includes:

When it is detected that the lens movement object is an intersection in the three-dimensional virtual scene, a movement direction of the virtual object is determined as the lens orientation.

As another implementation, the obtaining a lens orientation corresponding to the lens movement object includes:

When it is detected that the lens movement object is a target building in the three-dimensional virtual scene, a direction from a position of the virtual object to a position of the target building is determined in a ground coordinate system of the three-dimensional virtual scene as the lens orientation.

The virtual movement trajectory further includes a plurality of normal control nodes which divide the virtual movement trajectory into a plurality of sub-trajectories, each sub-trajectory of the plurality of sub-trajectories corresponding to a reference priority. Before the obtaining a lens orientation corresponding to the lens movement object in operation C3, the method further includes:

A sub-trajectory where the lens movement control node is located is selected from the plurality of sub-trajectories as a target sub-trajectory.

Exemplarily, the first sub-trajectory, the second sub-trajectory, the third sub-trajectory, and the fourth sub-trajectory in the above embodiments are taken as examples for illustration. As shown in Table 1, each sub-trajectory corresponds to a reference priority in advance.

TABLE 1

| Sub-trajectory identifier | Reference priority |
|---|---|
| First sub-trajectory | N1 |
| Second sub-trajectory | N2 |
| Third sub-trajectory | N3 |
| Fourth sub-trajectory | N4 |

For example, when it is detected that the sub-trajectory where the lens movement control node reached by the virtual object is located is the first sub-trajectory, the first sub-trajectory may be used as the target sub-trajectory.

A reference priority corresponding to the target sub-trajectory and a priority of the lens movement object are obtained.

Following the above examples, the reference priority N1 corresponding to the first sub-trajectory can be found from Table 1. Different lens movement objects are pre-associated with different priorities. For example, the priority of the current lens movement object may be M.

The priority of the lens movement object is compared with the reference priority.

Following the above examples, the priority M of the current lens movement object may be compared with the reference priority N1 to determine whether the priority M of the current lens movement object is greater than or equal to the reference priority N1.

When the priority of the lens movement object is greater than or equal to the reference priority, the operation of obtaining a lens orientation corresponding to the lens movement object is performed.

Following the above examples, if the priority M of the current lens movement object is greater than or equal to the reference priority N1, a subsequent operation of obtaining a lens orientation corresponding to the lens movement object may be performed to continue the lens movement operation for the lens movement object. If the priority M of the current lens movement object is less than the reference priority N1, the lens movement operation for the lens movement object may be canceled.

A reference priority corresponding to each sub-trajectory is positively correlated with a distance from the sub-trajectory to a starting point of the virtual movement trajectory.

Following the above examples of Table 1, in Table 1, the reference priority N1 is greater than the reference priority N2, the reference priority N2 is greater than the reference priority N3, and the reference priority N3 is greater than the reference priority N4. That is, for the same lens movement object, the later in the movement trajectory playback, the more difficult it is to trigger the lens movement operation.

Considering that at the latter part of the movement trajectory playback, the frequency of reaching lens movement control nodes significantly increases due to the higher movement speed of the virtual object, which may affect the user's experience of viewing the playback. In this implementation, lens movement objects are assigned priorities, and reference priorities are set for sub-trajectories in different segments of the virtual movement trajectory. Whether to perform a lens movement operation is determined by comparing the priority with the reference priority, thereby ensuring that the number of lens movement operations triggered in each sub-trajectory remains within an appropriate range and does not affect the user's viewing experience.

In some embodiments, for each sub-trajectory, an upper limit may be set on the number of lens movement operations that can be triggered corresponding to the sub-trajectory. During trajectory playback, if the number of lens movement operations triggered by the virtual object within the sub-trajectory reaches the upper limit, no further lens movement operations are performed.

In some embodiments, in the virtual movement trajectory, if the trajectory length between the current lens movement control node and the previous lens movement control node is less than or equal to a specified trajectory length, the current lens movement control node does not trigger a lens movement operation.

In some embodiments, in the virtual movement trajectory, if the interval duration between the current lens movement control node and the previous lens movement control node is less than or equal to a specified duration, the current lens movement control node does not trigger a lens movement operation.

C4: Control, based on the lens orientation, the virtual lens to capture the image of the virtual object moving along the virtual movement trajectory.

Exemplarily, in an example where the virtual object is a vehicle, the default initial lens orientation of the virtual lens is along the route direction of the vehicle's current movement path. When the lens movement object is detected as an intersection in the three-dimensional virtual scene, the movement direction of the vehicle may be determined as the lens orientation. When the vehicle passes through the intersection, the virtual lens is gradually switched from the initial lens orientation to the lens orientation, and when the vehicle exits the intersection, the lens orientation of the virtual lens is switched back to the initial lens orientation. The movement direction of the vehicle can be regarded as the heading direction of the vehicle. The route direction is road-related and is independent of the movement direction of the vehicle.

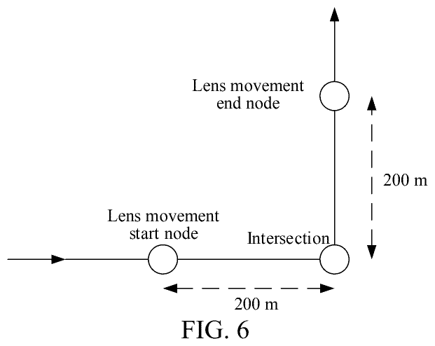

As an example, as shown in FIG. 6, in the virtual movement trajectory, when the virtual object is 200 meters from entering an intersection (lens movement start node), the lens orientation may begin to switch to the movement direction of the virtual object. When the virtual object is 200 meters past the intersection (lens movement end node) in the virtual movement trajectory, the lens orientation may begin to switch to the initial lens orientation.

In some implementations, each lens movement control node in the virtual movement trajectory may be pre-associated with a set of control parameters. When the virtual object reaches a lens movement control node, the virtual lens may be controlled using not only the lens orientation corresponding to the lens movement control node but also the control parameters corresponding to the lens movement control node, and the movement speed of the virtual object may be controlled. For example, when the virtual object enters an intersection, the map scale of the virtual lens may be adjusted to 1:1, and the virtual lens angle may be adjusted to −20°.

205: Display the image.

In this embodiment, a three-dimensional virtual scene is obtained, and a real movement trajectory of a real object is determined. Then, the real movement trajectory is mapped to the three-dimensional virtual scene to obtain a virtual movement trajectory. Thereafter, in the three-dimensional virtual scene, a virtual object corresponding to the real object and a virtual lens corresponding to the virtual object are set, a preset relative positional relationship between the virtual lens and the virtual object being maintained. Subsequently, the virtual object is controlled to move along the virtual movement trajectory, and the virtual lens is controlled to capture an image of the virtual object moving along the virtual movement trajectory. Finally, the image is displayed. Since the preset relative positional relationship between the virtual lens and the virtual object is maintained in the three-dimensional virtual scene, when the virtual object moves along the virtual movement trajectory, the virtual lens can follow the virtual object to move in real time and capture an image of the surrounding environment of the virtual object during the movement. As the image is captured in the three-dimensional virtual scene, the captured image can be presented in a three-dimensional form, allowing the map elements in the three-dimensional virtual scene to be displayed with enhanced detail and richness, and accurately reconstructing the real movement trajectory. Moreover, it enables the user to immerse themselves and realistically experience their prior movement process in reality, thereby improving the user's experience when viewing the movement trajectory playback.

According to the methods described in the above embodiments, further details are described below.

In this embodiment, the method of the embodiments of this application is described in detail using an electronic device as an example.

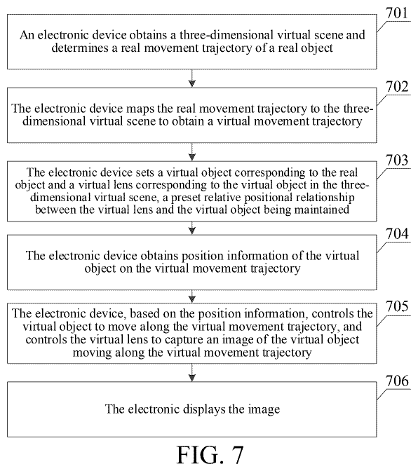

As shown in FIG. 7, a specific flow of a movement trajectory playback method is as follows:

701: The electronic device obtains a three-dimensional virtual scene and determines a real movement trajectory of a real object.

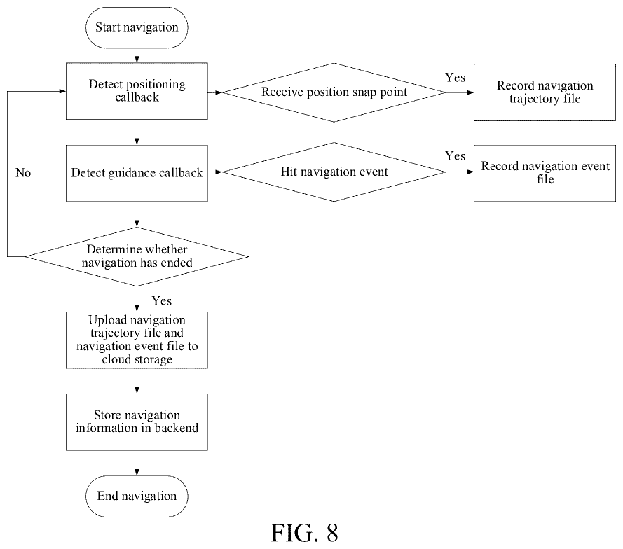

Exemplarily, the method for obtaining driving data may be as shown in FIG. 8.

During the actual vehicle navigation movement process, after navigation has started, a positioning callback can be detected. The positioning callback detection refers to setting a callback function or delegate when using a positioning service, which is automatically invoked upon a change in the positioning result to update the position information, thereby enabling real-time obtaining of the positioning information of the vehicle. The positioning information may include longitude, latitude, altitude, and the like. The accuracy of the positioning information can be custom-set, for example, to six decimal places.

Upon determining that a positioning snap point has been received, that is, upon receiving an instruction to record the current positioning information, the current positioning information is recorded into the navigation trajectory file.

In addition, a guidance callback can be detected simultaneously to determine whether a navigation event is triggered. The navigation event may be a preset event, such as arriving at an intersection or passing a special building. When it is determined that a navigation event has been triggered, the event information is recorded into the navigation event file. In some embodiments, the event information may be included.

Thereafter, it is determined whether the navigation has ended. If so, the navigation event file and the navigation trajectory file are uploaded to cloud storage. Navigation information is then obtained based on the navigation event file and the navigation trajectory file, and the navigation information for the current navigation is stored in the backend to obtain driving data. The navigation is subsequently ended. The navigation information may include the start location, destination, speed, positioning information, data accuracy, and other information about the current navigation. If the navigation has not ended, the process performs the operation of detecting the positioning callback.

The driving data obtained as described above may be configured not only for movement trajectory playback but also for other scenarios, such as augmented reality (AR) human-machine interaction, which are not limited thereto.

702: The electronic device maps the real movement trajectory to the three-dimensional virtual scene to obtain a virtual movement trajectory.

703: The electronic device sets a virtual object corresponding to the real object and a virtual lens corresponding to the virtual object in the three-dimensional virtual scene, a preset relative positional relationship between the virtual lens and the virtual object being maintained.

704: The electronic device obtains position information of the virtual object on the virtual movement trajectory.

705: The electronic device, based on the position information, controls the virtual object to move along the virtual movement trajectory, and controls the virtual lens to capture an image of the virtual object moving along the virtual movement trajectory.

The controlling, based on the position information, the virtual object to move along the virtual movement trajectory may include: According to the position information, a remaining trajectory length of the virtual object is determined, the remaining trajectory length being a length of the portion of the virtual movement trajectory that the virtual object has not traversed. According to the remaining trajectory length, a target movement speed of the virtual object is determined, the target movement speed being negatively correlated with the remaining trajectory length. Based on the target movement speed, the virtual object is controlled to move along the virtual movement trajectory.

The controlling, based on the position information, the virtual lens to capture the image of the virtual object moving along the virtual movement trajectory further includes: According to the remaining trajectory length, a target virtual lens angle of the virtual lens is determined, where the target virtual lens angle is positively correlated with the remaining trajectory length, the target virtual lens angle being a pitch angle of the virtual lens, and the target virtual lens angle ranging from −90 degrees to 0 degrees. Based on the target virtual lens angle, the virtual lens is controlled to capture the image of the virtual object moving along the virtual movement trajectory.

The controlling, based on the position information, the virtual lens to capture the image of the virtual object moving along the virtual movement trajectory includes: According to the remaining trajectory length, a target map scale corresponding to the virtual lens is determined, the target map scale being positively correlated with the remaining trajectory length. Based on the target map scale, the virtual lens is controlled to capture the image of the virtual object moving along the virtual movement trajectory.

In some implementations, the virtual movement trajectory includes a plurality of control nodes. The based on the position information, controlling the virtual object to move along the virtual movement trajectory, and controlling the virtual lens to capture the image of the virtual object moving along the virtual movement trajectory includes: When it is determined, according to the position information, that the virtual object has arrived at a control node, a control strategy corresponding to the control node is obtained. Based on the control strategy corresponding to the control node, the virtual object is controlled to move along the virtual movement trajectory, and the virtual lens is controlled to capture the image of the virtual object moving along the virtual movement trajectory.

The based on the control strategy corresponding to the control node, controlling the virtual object to move along the virtual movement trajectory, and controlling the virtual lens to capture the image of the virtual object moving along the virtual movement trajectory includes: A type of the control node is obtained. When the control node is a normal control node, control parameters corresponding to the normal control node are obtained, the control parameters including a movement speed of the virtual object, a virtual lens angle of the virtual lens, and a map scale corresponding to the virtual lens, the virtual lens angle being a pitch angle of the virtual lens, and the virtual lens angle ranging from −90 degrees to 0 degrees. Based on the movement speed, the virtual object is controlled to move along the virtual movement trajectory. Based on the virtual lens angle and the map scale, the virtual lens is controlled to capture the image of the virtual object moving along the virtual movement trajectory.

The normal control node includes a first control node, a second control node, and a third control node, and the first control node, the second control node, and the third control node divide the virtual movement trajectory into a first sub-trajectory, a second sub-trajectory, a third sub-trajectory, and a fourth sub-trajectory. The first sub-trajectory is a trajectory between the first control node and a starting point of the virtual movement trajectory. The second sub-trajectory is a trajectory between the first control node and the second control node. The third sub-trajectory is a trajectory between the second control node and the third control node. The fourth sub-trajectory is a trajectory between the third control node and an end point of the virtual movement trajectory. A ratio of trajectory lengths of the first sub-trajectory, the second sub-trajectory, the third sub-trajectory, and the fourth sub-trajectory is 2:1:2:5.

Control parameters corresponding to the first control node include a first movement speed, a first virtual lens angle, and a first map scale. Control parameters corresponding to the second control node include a second movement speed, a second virtual lens angle, and a second map scale. Control parameters corresponding to the third control node include a third movement speed, a third virtual lens angle, and a third map scale. The first movement speed is less than the second movement speed, and the second movement speed is less than the third movement speed. The first virtual lens angle is greater than or equal to the second virtual lens angle, and the second virtual lens angle is greater than the third virtual lens angle. The first map scale is greater than the second map scale, and the second map scale is greater than the third map scale.

The based on the control strategy corresponding to the control node, controlling the virtual object to move along the virtual movement trajectory, and controlling the virtual lens to capture the image of the virtual object moving along the virtual movement trajectory includes: A type of the control node is obtained. When the control node is a lens movement control node, a lens movement object corresponding to the lens movement control node is determined. A lens orientation corresponding to the lens movement object is obtained. Based on the lens orientation, the virtual lens is controlled to capture the image of the virtual object moving along the virtual movement trajectory.

The obtaining a lens orientation corresponding to the lens movement object includes: When it is detected that the lens movement object is an intersection in the three-dimensional virtual scene, a movement direction of the virtual object is determined as the lens orientation. The obtaining a lens orientation corresponding to the lens movement object includes: When it is detected that the lens movement object is a target building in the three-dimensional virtual scene, a direction from a position of the virtual object to a position of the target building is determined in a ground coordinate system of the three-dimensional virtual scene as the lens orientation.

The virtual movement trajectory further includes a plurality of normal control nodes which divide the virtual movement trajectory into a plurality of sub-trajectories, each sub-trajectory of the plurality of sub-trajectories corresponding to a reference priority. Before the obtaining a lens orientation corresponding to the lens movement object, the method further includes: A sub-trajectory where the lens movement control node is located is selected from the plurality of sub-trajectories as a target sub-trajectory.

A reference priority corresponding to the target sub-trajectory and a priority of the lens movement object are obtained. The priority of the lens movement object is compared with the reference priority. When the priority of the lens movement object is greater than or equal to the reference priority, the operation of obtaining a lens orientation corresponding to the lens movement object is performed. A reference priority corresponding to each sub-trajectory is positively correlated with a distance from the sub-trajectory to a starting point of the virtual movement trajectory.

706: The electronic device displays the image.

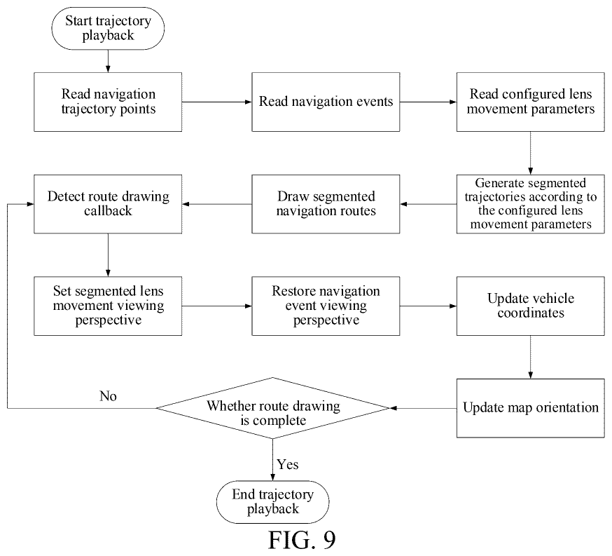

Exemplarily, in combination with the above operations 701 to 706, a specific implementation flow of the electronic device performing movement trajectory playback may be as shown in FIG. 9.

After starting the movement trajectory playback, the navigation trajectory points, navigation events, and configured lens movement parameters are read. The navigation trajectory points may be read from the above navigation trajectory file, the navigation events may be read from the above navigation event file, and the configured lens movement parameters may be custom-set by the user. The configured lens movement parameter may correspond to the above control parameters.

Then, according to the configured lens movement parameters, segmented trajectories are generated, such as the first sub-trajectory and the second sub-trajectory as described above.

Thereafter, a segmented navigation route drawing callback is executed, that is, whether a navigation event is triggered in the trajectory drawing process is detected, and when triggered, a segmented lens movement viewing perspective is set, and the navigation event viewing perspective is restored through the segmented lens movement viewing perspective.

Moreover, the vehicle coordinates and the displayed map orientation are updated, where the map orientation may correspond to the lens orientation described in the above embodiments.

Subsequently, it may be determined whether the navigation route drawing is complete. If so, the movement trajectory playback is ended; if not, the process performs the operation of detecting the route drawing callback.

As a more specific example, the trajectory to be played back may be divided into four segments, such as a first segment, a second segment, a third segment, and a fourth segment. In some embodiments, the navigation distance range supported by the movement trajectory playback may be 0 to 50 kilometers. The total playback duration of the movement trajectory playback may be controlled within 7 to 30 seconds. The movement trajectory playback speed (e.g., the movement speed of the above virtual object) may be classified as slow speed, medium speed, or fast speed, where the slow speed is 500 m/s, the medium speed is 2000 m/s, and the fast speed is 5000 m/s.

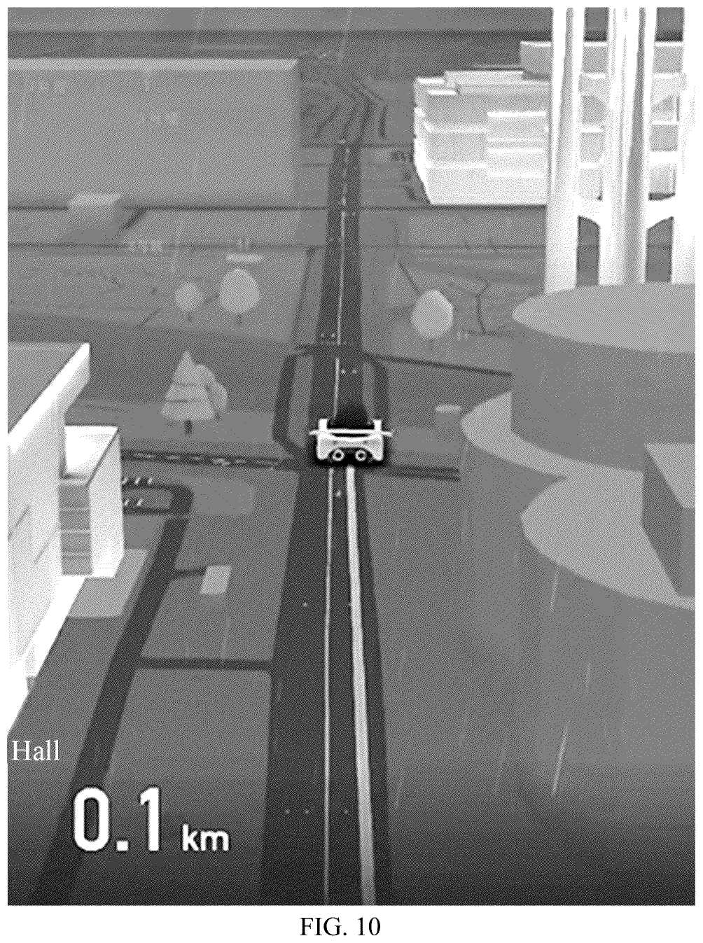

For the first segment of the trajectory to be played back, it may correspond to 0 to 20% of the trajectory. In the first segment, the movement trajectory playback speed may be set to slow speed, and the playback duration may range from 3 to 12 seconds. In addition, the playback image of the first segment may be as shown in FIG. 10. In the image, the map scale is level 18 (e.g., each unit length on the map represents 10 meters on the ground), the map pitch angle is 80°, and the map orientation corresponds to the route orientation of the vehicle's current movement path. The map pitch angle may correspond to the virtual lens angle in the above embodiments. The map pitch angle α may have the following relationship with the virtual lens angle B in the above embodiments: α−(90°+β). For example, a map pitch angle of 0° corresponds to a virtual lens angle of −90°, a map pitch angle of 90° corresponds to a virtual lens angle of 0°, and a map pitch angle of 70° corresponds to a virtual lens angle of −20°.

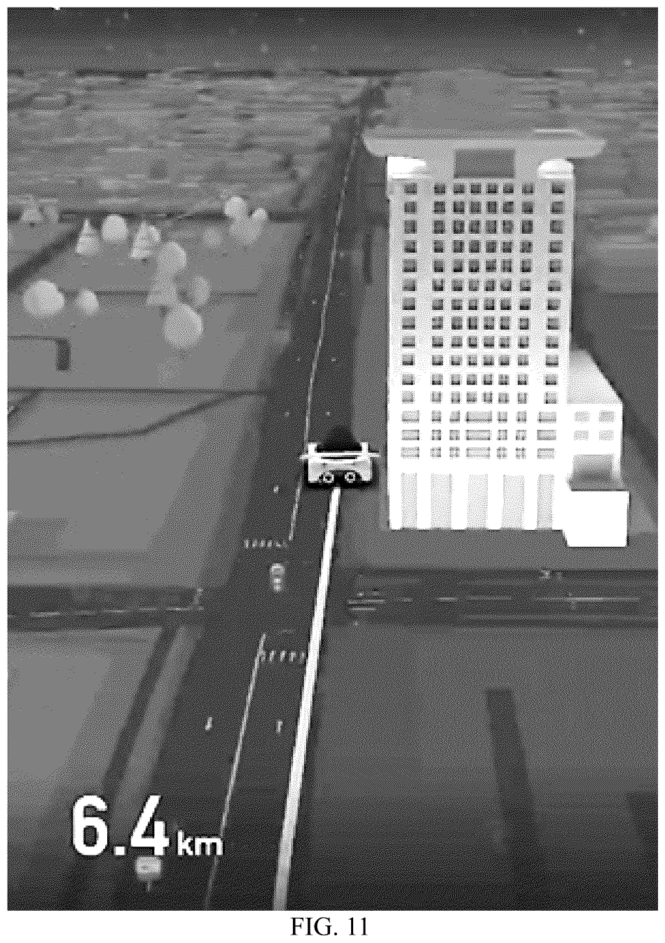

For the second segment of the trajectory to be played back, it may correspond to 20% to 30% of the trajectory. In the second segment, the movement trajectory playback speed may be set to slow speed, and the playback duration may range from 2 to 8 seconds. In addition, the playback image of the second segment may be as shown in FIG. 11. In the image, the map scale is level 17 (e.g., each unit length on the map represents 20 meters on the ground), the map pitch angle is 70°, and the map orientation corresponds to the route orientation of the vehicle's current movement path. Compared with the first segment, the image content displayed in the second segment is more concise.

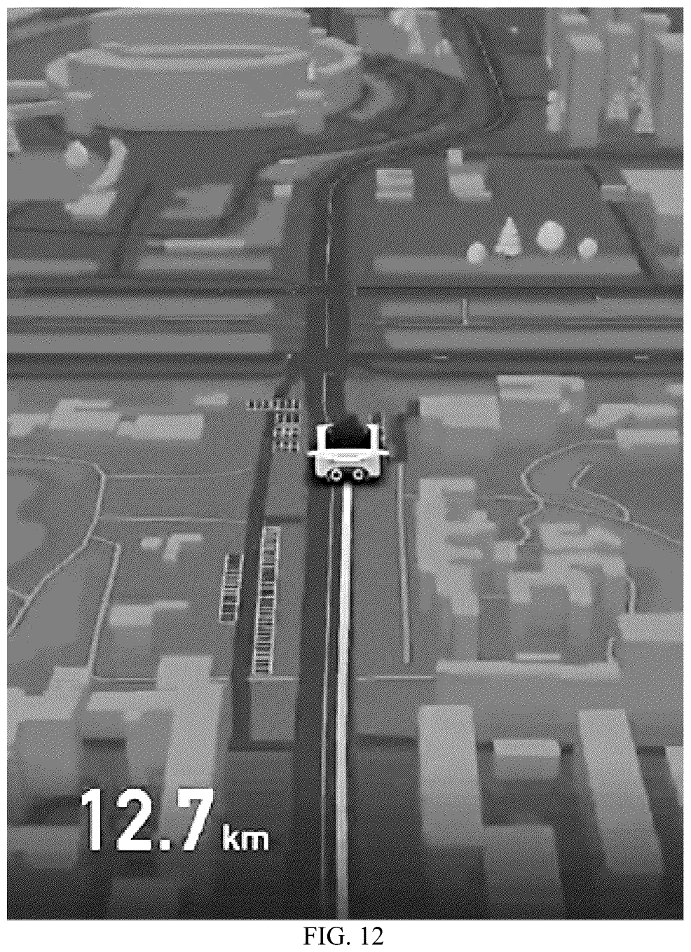

For the third segment of the trajectory to be played back, it may correspond to 30% to 50% of the trajectory. In the third segment, the movement trajectory playback speed may be set to medium speed, and the playback duration may range from 1 to 5 seconds. In addition, the playback image of the third segment may be as shown in FIG. 12. In the image, the map scale is level 16 (e.g., each unit length on the map represents 50 meters on the ground), the map pitch angle is 70°, and the map orientation corresponds to the route orientation of the vehicle's current movement path. Compared with the second segment, the image content displayed in the third segment is more concise, and the buildings in the image are less detailed than those in the second segment.

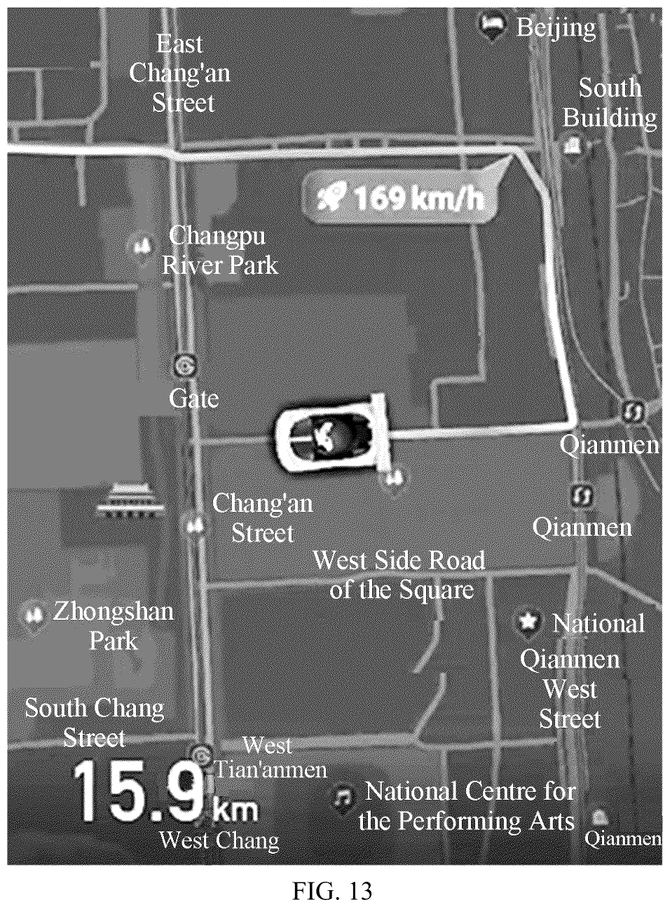

For the fourth segment of the trajectory to be played back, it may correspond to 50% to 100% of the trajectory. In the fourth segment, the movement trajectory playback speed may be set to fast speed, and the playback duration may range from 1 to 5 seconds. In addition, the playback image of the fourth segment may be as shown in FIG. 13. In the image, the map scale is level 15 (e.g., each unit length on the map represents 100 meters on the ground), and the map pitch angle is 0°. In some embodiments, the vehicle's speed and current travel distance may be displayed in the playback image.

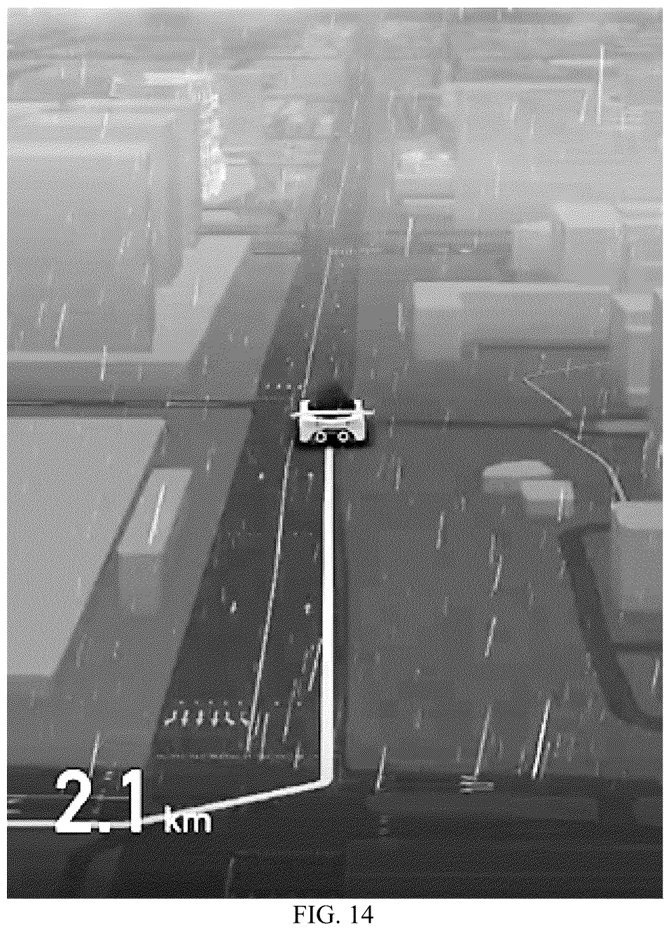

As an example, when the playback reaches the point where the vehicle passes an intersection (e.g., exits the intersection), the playback image may be as shown in FIG. 14. In the image, the map scale is level 21 (e.g., each unit length on the map represents 1 meter on the ground), the map pitch angle is 80°, and through corresponding lens movement processing, the map orientation can be set to the heading direction of the vehicle. In some embodiments, as shown in FIG. 14, corresponding weather elements may be displayed in the playback image according to the weather information obtained from the driving data. For example, rainy weather elements may be displayed on the map.

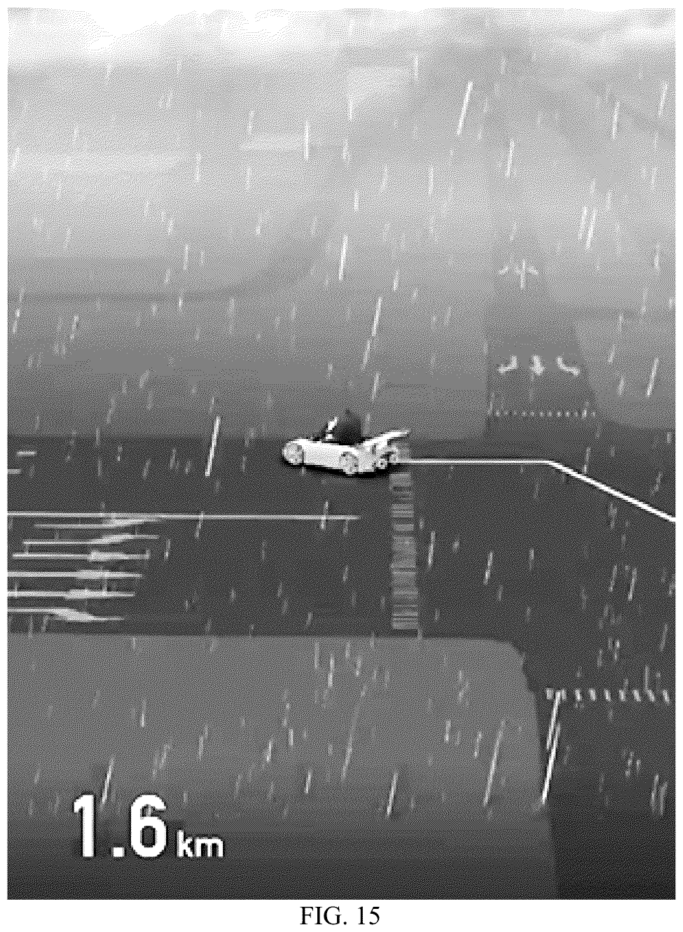

In some embodiments, as shown in FIG. 15, when the playback reaches the point where the vehicle is turning at an intersection, the lens orientation may be adjusted toward the corner of the intersection to observe the vehicle's turning process.

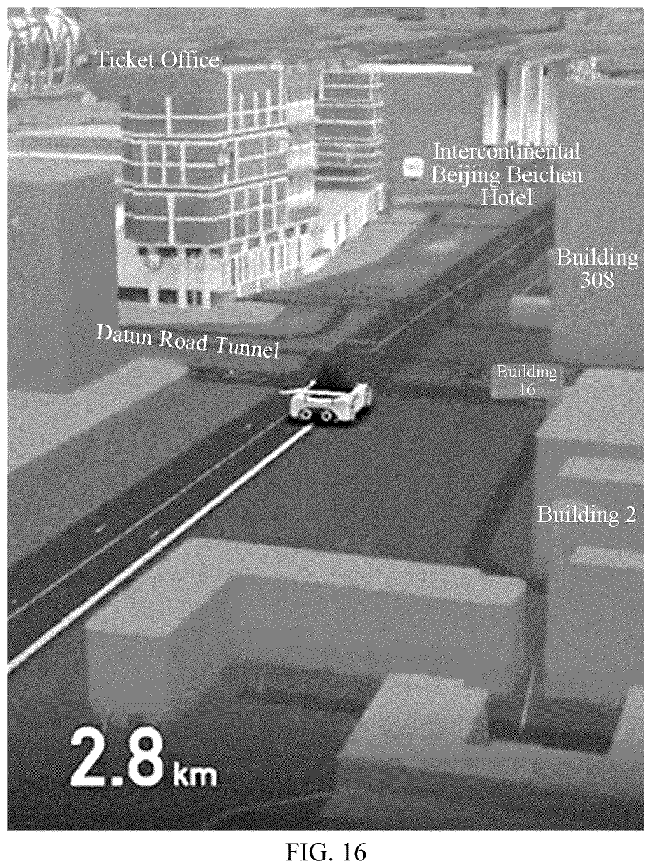

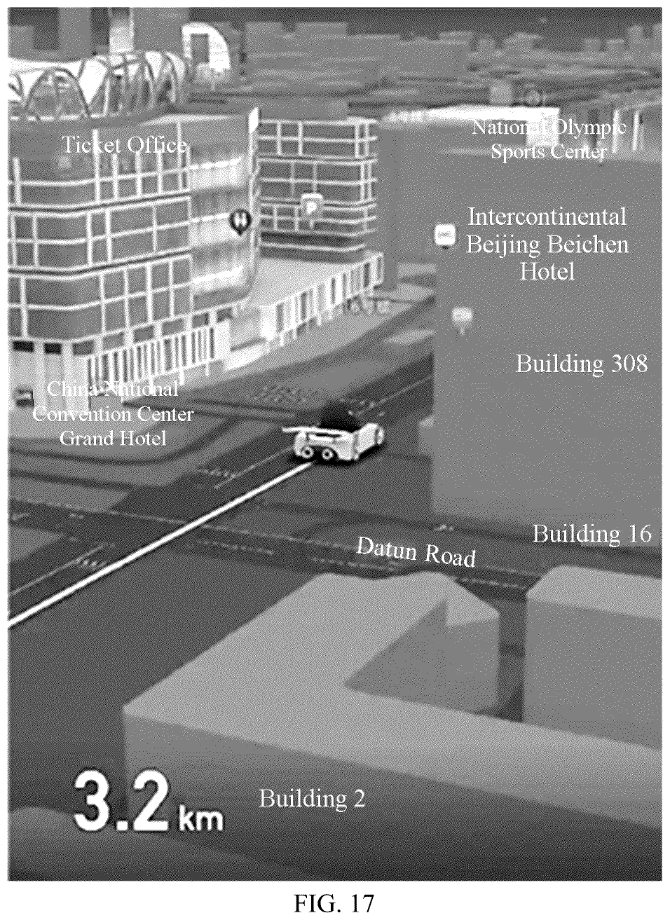

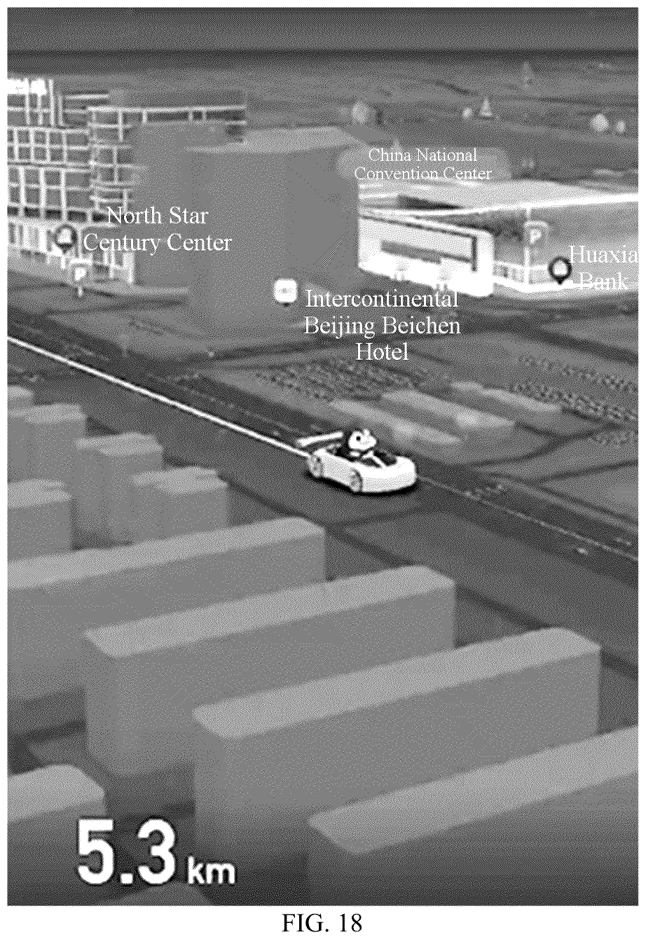

In some implementations, when the playback reaches the point where the vehicle passes a special building requiring lens movement, the map scale and map pitch angle may remain unchanged, and the lens orientation may be kept aligned with the direction from the vehicle's current position to the position of the special building. Exemplarily, as shown in FIG. 16, when the vehicle is approaching the special building, the special building may appear at the front-left of the vehicle in the displayed playback image; as shown in FIG. 17, when the vehicle is passing the special building, the special building may appear at the left side of the vehicle in the displayed playback image; and as shown in FIG. 18, after the vehicle has passed the special building, the special building may appear at the rear-left of the vehicle in the displayed playback image. By displaying the series of images described above, a surround-view effect of the special building can be achieved.

The lens movement operation may start when the vehicle begins to pass the special building and automatically end after a specified duration (e.g., 2 seconds).

For the lens movement object, other lens movement methods may be employed in addition to the above lens movement methods, such as having the virtual lens circle around the special building, which are not limited thereto.

In this embodiment, by performing movement trajectory playback in an immersive manner in the three-dimensional virtual scene, the map elements are displayed in a more detailed and enriched manner. The trajectory is controlled using a segmentation strategy, with the playback speed and playback duration of each segment dynamically configured and calculated. Moreover, the map scale, pitch angle, and orientation are dynamically adjusted according to the road segment of the vehicle's route. For example, during the first half of the playback, more lens movement effects are presented to enhance immersion in the field of view, with a relatively slower playback speed to enhance the user's viewing experience; during the latter half, the playback speed is increased to avoid visual fatigue for the user. Special virtual lens viewpoints may be set for key navigation scenes, such as intersections and special landmark buildings for display, thereby presenting the details of the special landmark buildings and reconstructing the real navigation scenario for the user. This can address the problem in the related art where the field of view, map scale, and pitch angle during movement trajectory playback are fixed, the map orientation is static, and the vehicle movement is mostly played back in a two-dimensional plane, making it difficult to observe the details of surrounding map elements during navigation and failing to accurately reconstruct the user's real navigation scenario, resulting in a suboptimal viewing experience. Consequently, the user's experience of viewing the movement trajectory playback is improved.

To better implement the above method, the embodiments of this application further provide a movement trajectory playback apparatus. The movement trajectory playback apparatus can be specifically integrated into an electronic device, which may be a terminal, a server, or the like. The terminal may be a mobile phone, a tablet computer, a smart Bluetooth device, a laptop, a PC, or the like. The server may be a single server or a server cluster including a plurality of servers.

For example, in this embodiment, the method of the embodiments of this application is described in detail in an example where the movement trajectory playback apparatus is specifically integrated into the movement trajectory playback.

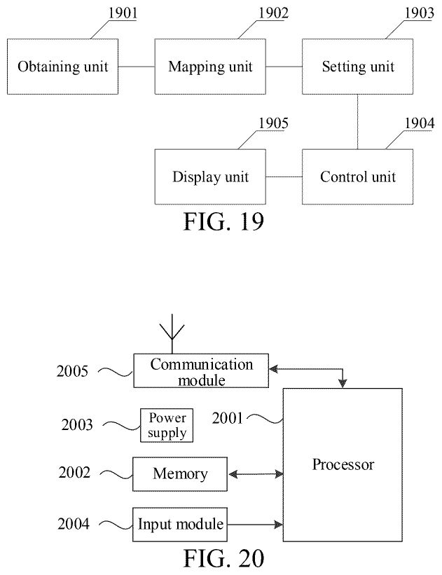

For example, as shown in FIG. 19, the movement trajectory playback apparatus may include an obtaining unit 1901, a mapping unit 1902, a setting unit 1903, a control unit 1904, and a display unit 1905 as follows:

The obtaining unit 1901 is configured to obtain a three-dimensional virtual scene and determine a real movement trajectory of a real object.

The mapping unit 1902 is configured to map the real movement trajectory to the three-dimensional virtual scene to obtain a virtual movement trajectory.

The setting unit 1903 is configured to set, in the three-dimensional virtual scene, a virtual object corresponding to the real object and a virtual lens corresponding to the virtual object, a preset relative positional relationship between the virtual lens and the virtual object being maintained.

The control unit 1904 is configured to control the virtual object to move along the virtual movement trajectory, and control the virtual lens to capture an image of the virtual object moving along the virtual movement trajectory.

The display unit 1905 is configured to display the image.

In some implementations, the control unit 1904 includes:
a position obtaining sub-unit, configured to obtain position information of the virtual object on the virtual movement trajectory; and
a control sub-unit, configured to, based on the position information, control the virtual object to move along the virtual movement trajectory, and control the virtual lens to capture an image of the virtual object moving along the virtual movement trajectory.

In some implementations, the control sub-unit is specifically configured to:
determine, according to the position information, a remaining trajectory length of the virtual object, the remaining trajectory length being a length of the portion of the virtual movement trajectory that the virtual object has not traversed;
determine, according to the remaining trajectory length, a target movement speed of the virtual object, the target movement speed being negatively correlated with the remaining trajectory length; and
control, based on the target movement speed, the virtual object to move along the virtual movement trajectory.

In some implementations, the control sub-unit is further specifically configured to:
determine, according to the remaining trajectory length, a target virtual lens angle of the virtual lens, the target virtual lens angle being positively correlated with the remaining trajectory length, the target virtual lens angle being a pitch angle of the virtual lens, and the target virtual lens angle ranging from −90 degrees to 0 degrees; and

control, based on the target virtual lens angle, the virtual lens to capture the image of the virtual object moving along the virtual movement trajectory.

In some implementations, the control sub-unit is further specifically configured to:
determine, according to the remaining trajectory length, a target map scale corresponding to the virtual lens, the target map scale being positively correlated with the remaining trajectory length; and
control, based on the target map scale, the virtual lens to capture the image of the virtual object moving along the virtual movement trajectory.

In some implementations, the virtual movement trajectory includes a plurality of control nodes, and the control sub-units includes:
a strategy obtaining module, configured to, when it is determined, according to the position information, that the virtual object has arrived at a control node, obtain a control strategy corresponding to the control node; and
a control module, configured to, based on the control strategy corresponding to the control node, control the virtual object to move along the virtual movement trajectory, and control the virtual lens to capture an image of the virtual object moving along the virtual movement trajectory.

In some implementations, the control module includes:
a type obtaining sub-module, configured to obtain a type of the control node;
a parameter obtaining sub-module, configured to, when the control node is a normal control node, obtain control parameters corresponding to the normal control node, the control parameters including a movement speed of the virtual object, a virtual lens angle of the virtual lens, and a map scale corresponding to the virtual lens, the virtual lens angle being a pitch angle of the virtual lens, and the virtual lens angle ranging from −90 degrees to 0 degrees;

a speed control sub-module, configured to control, based on the target movement speed, the virtual object to move along the virtual movement trajectory; and

a first virtual lens control sub-module, configured to control, based on the virtual lens angle and the map scale, the virtual lens to capture the image of the virtual object moving along the virtual movement trajectory.

In some implementations, the normal control node includes a first control node, a second control node, and a third control node, and the first control node, the second control node, and the third control node divide the virtual movement trajectory into a first sub-trajectory, a second sub-trajectory, a third sub-trajectory, and a fourth sub-trajectory.

The first sub-trajectory is a trajectory between the first control node and a starting point of the virtual movement trajectory.

The second sub-trajectory is a trajectory between the first control node and the second control node.

The third sub-trajectory is a trajectory between the second control node and the third control node.

The fourth sub-trajectory is a trajectory between the third control node and an end point of the virtual movement trajectory.

A ratio of trajectory lengths of the first sub-trajectory, the second sub-trajectory, the third sub-trajectory, and the fourth sub-trajectory is 2:1:2:5.

In some implementations, control parameters corresponding to the first control node include a first movement speed, a first virtual lens angle, and a first map scale.

Control parameters corresponding to the second control node include a second movement speed, a second virtual lens angle, and a second map scale.

Control parameters corresponding to the third control node include a third movement speed, a third virtual lens angle, and a third map scale.

The first movement speed is less than the second movement speed, and the second movement speed is less than the third movement speed.

The first virtual lens angle is greater than or equal to the second virtual lens angle, and the second virtual lens angle is greater than the third virtual lens angle.

The first map scale is greater than the second map scale, and the second map scale is greater than the third map scale.

In some implementations, the control module includes:
a type obtaining sub-module, configured to obtain a type of the control node;
an object determination sub-module, configured to, when the control node is a lens movement control node, determine a lens movement object corresponding to the lens movement control node;
an orientation obtaining sub-module, configured to obtain a lens orientation corresponding to the lens movement object; and
a second virtual lens control sub-module, configured to control, based on the lens orientation, the virtual lens to capture the image of the virtual object moving along the virtual movement trajectory.

In some implementations, the orientation obtaining sub-module is specifically configured to:
when it is detected that the lens movement object is an intersection in the three-dimensional virtual scene, determine a movement direction of the virtual object as the lens orientation.

In some implementations, the orientation obtaining sub-module is specifically configured to:
when it is detected that the lens movement object is a target building in the three-dimensional virtual scene, determine, in a ground coordinate system of the three-dimensional virtual scene, a direction from a position of the virtual object to a position of the target building as the lens orientation.

In some implementations, the virtual movement trajectory further includes a plurality of normal control nodes which divide the virtual movement trajectory into a plurality of sub-trajectories, each sub-trajectory of the plurality of sub-trajectories corresponding to a reference priority. The apparatus further includes:
a selection unit, configured to select, from the plurality of sub-trajectories, a sub-trajectory where the lens movement control node is located as a target sub-trajectory;
a priority obtaining unit, configured to obtain a reference priority corresponding to the target sub-trajectory and a priority of the lens movement object;
a priority comparison unit, configured to compare the priority of the lens movement object with the reference priority; and
an execution unit, configured to, when the priority of the lens movement object is greater than or equal to the reference priority, perform the operation of obtaining a lens orientation corresponding to the lens movement object.

In some implementations, a reference priority corresponding to each sub-trajectory is positively correlated with a distance from the sub-trajectory to a starting point of the virtual movement trajectory.

In specific implementations, the above units may be implemented as an independent entity, or may be arbitrarily combined and implemented as the same entity or a plurality of entities. The specific implementations of the above units can refer to the foregoing method embodiments and are not repeated herein.

The embodiments of this application further provide an electronic device, which may be a terminal, a server, or the like. The terminal may be a mobile phone, a tablet computer, a smart Bluetooth device, a laptop, a PC, or the like. The server may be a single server, a server cluster including a plurality of servers, or the like.

In some embodiments, the movement trajectory playback apparatus may further be integrated into a plurality of electronic devices. For example, the movement trajectory playback apparatus may be integrated into a plurality of servers, and the movement trajectory playback method of this application may be implemented by the plurality of servers.

In this embodiment, a detailed description is provided for the electronic device. For example, as shown in FIG. 20, a schematic structural diagram of an electronic device involved in the embodiments of this application is shown.

In particular, the electronic device may include components such as a processor 2001 including one or more processing cores, a memory 2002 including one or more computer-readable storage media, a power supply 2003, an input module 2004, and a communication module 2005. A person skilled in the art can understand that the structure of the electronic device shown in FIG. 20 does not constitute a limit to the electronic device. The server may include more or fewer parts than those shown in the figure, may combine some parts, or may have different part arrangements.

The processor 2001 serves as the control center of the electronic device, connecting various parts of the electronic device via a plurality of interfaces and circuits. By running or executing software programs and/or modules stored in the memory 2002, and by accessing data stored in the memory 2002, the processor performs various functions and processes data, thereby enabling overall monitoring of the electronic device. In some embodiments, the processor 2001 may include one or more processing cores. In some embodiments, the processor 2001 may integrate an application processor and a modem processor, where the application processor primarily handles the operating system, user interface, application programs, and the like, while the modem processor primarily handles wireless communications. The modem processor may not be integrated into the processor 2001.

The memory 2002 may be configured to store software programs and modules. The processor 2001 executes various functional applications and performs data processing by running the software programs and modules stored in the memory 2002. The memory 2002 may mainly include a program storage area and a data storage area. The program storage area may store an operating system, at least one application program required for a function (e.g., audio playback function and image playback function), and the like. The data storage area may store data generated according to the use of the electronic device, and the like. In addition, the memory 2002 may include high-speed random-access memory, and may further include non-volatile memory, such as at least one magnetic storage device, flash memory device, or other non-volatile solid-state memory device. Accordingly, the memory 2002 may further include a memory controller for enabling the processor 2001 to access the memory 2002.

The electronic device further includes the power supply 2003 for supplying power to the components. In some embodiments, the power supply 2003 may be logically connected to the processor 2001 via a power management system, thereby enabling the management of functions such as charging, discharging, and power consumption via the power management system. The power supply 2003 may further include one or more components, such as a direct current (DC) or alternating current (AC) power source, a recharging system, a power failure detection circuit, a power converter or inverter, a power status indicator, and the like.

The electronic device may further include an input module 2004, which may be configured to receive digital or character input and to generate signals related to user settings and function control, such as inputs from a keyboard, mouse, joystick, optical device, or trackball.

The electronic device may further include a communication module 2005. In some embodiments, the communication module 2005 may include a wireless module, enabling the electronic device to perform short-range wireless transmissions via the wireless module of the communication module 2005 and thereby providing the user with wireless broadband Internet access. For example, the communication module 2005 may be configured to assist the user in sending and receiving e-mails, browsing web pages, accessing streaming media, and the like.

Although not shown, the electronic device may further include a display unit and other components, which are not repeated herein. In particular, in this embodiment, the processor 2001 of the electronic device loads the executable files corresponding to one or more application program processes into the memory 2002 according to the following instructions, and executes the application programs stored in the memory 2002, thereby implementing various functions.

The specific implementation of the above operations may refer to the foregoing embodiments and are not repeated herein.

A person of ordinary skill in the art can understand that all or part of the operations in various methods of the embodiments may be performed by instructions, or by instructions controlling relevant hardware. The instructions may be stored in a computer-readable storage medium and loaded and executed by the processor.

Accordingly, the embodiments of this application further provide a computer-readable storage medium having a plurality of instructions stored therein, the instructions being loadable by a processor to execute the operations of the movement trajectory playback method according to any one of the embodiments of this application.

The storage medium may include a read-only memory (ROM), a random-access memory (RAM), a disk, an optical disk, or the like.

According to one aspect of this application, a computer program product or a

computer program is provided, the computer program product or the computer program including computer instructions. The computer instructions are stored in a computer-readable storage medium. The processor of the electronic device reads the computer instructions from the computer-readable storage medium and executes the computer instructions, enabling the electronic device to perform the methods according to the above embodiments.

Since the instructions stored in the storage medium can execute the operations of the movement trajectory playback method according to any one of the embodiments of this application, the beneficial effects achievable by the movement trajectory playback method according to any one of the embodiments of this application can thus be realized. For details, reference may be made to the foregoing embodiments, which are not repeated herein.

Technical features of the foregoing embodiments may be combined in different manners to form other embodiments. For the sake of conciseness, not all possible combinations of the technical features in the above embodiments are described. However, as long as the combination of these technical features does not result in a conflict, it is to be considered within the scope of this specification.

The foregoing embodiments merely illustrate several implementations of this application, which are described in a specific and detailed manner, but cannot be construed as limiting the scope of the present disclosure. For a person of ordinary skill in the art, several transformations and improvements can be made without departing from the idea of this application. These transformations and improvements belong to the protection scope of this application. Therefore, the scope of protection of this application is to be defined by the appended claims.

What is claimed is:

1. A movement trajectory playback method performed by an electronic device, comprising:
obtaining a three-dimensional virtual scene;
determining a real movement trajectory of a real object;
mapping the real movement trajectory to the three-dimensional virtual scene to obtain a virtual movement trajectory;
setting, in the three-dimensional virtual scene, a virtual object corresponding to the real object and a virtual lens corresponding to the virtual object, a preset relative positional relationship between the virtual lens and the virtual object being maintained;
controlling the virtual object to move along the virtual movement trajectory, and controlling the virtual lens to capture an image of the virtual object moving along the virtual movement trajectory; and
displaying the image.

2. The movement trajectory playback method according to claim 1, wherein controlling the virtual object to move along the virtual movement trajectory and controlling the virtual lens to capture the image includes:
obtaining position information of the virtual object on the virtual movement trajectory; and
based on the position information, controlling the virtual object to move along the virtual movement trajectory, and controlling the virtual lens to capture the image of the virtual object moving along the virtual movement trajectory.

3. The movement trajectory playback method according to claim 2, wherein controlling, based on the position information, the virtual object to move along the virtual movement trajectory includes:
determining, according to the position information, a remaining trajectory length of the virtual object, the remaining trajectory length being a length of a portion of the virtual movement trajectory that the virtual object has not traversed;
determining, according to the remaining trajectory length, a target movement speed of the virtual object, the target movement speed being negatively correlated with the remaining trajectory length; and
controlling, based on the target movement speed, the virtual object to move along the virtual movement trajectory.

4. The movement trajectory playback method according to claim 3, wherein controlling, based on the position information, the virtual lens to capture the image includes:
determining, according to the remaining trajectory length, a target virtual lens angle of the virtual lens, the target virtual lens angle being a pitch angle of the virtual lens and being positively correlated with the remaining trajectory length; and
controlling, based on the target virtual lens angle, the virtual lens to capture the image of the virtual object moving along the virtual movement trajectory.

5. The movement trajectory playback method according to claim 3, wherein
controlling, based on the position information, the virtual lens to capture the image includes:
determining, according to the remaining trajectory length, a target map scale corresponding to the virtual lens, the target map scale being positively correlated with the remaining trajectory length; and
controlling, based on the target map scale, the virtual lens to capture the image of the virtual object moving along the virtual movement trajectory.

6. The movement trajectory playback method according to claim 2, wherein the virtual movement trajectory includes one or more control nodes, and based on the position information, controlling the virtual object to move along the virtual movement trajectory and controlling the virtual lens to capture the image includes:
in response to determining, according to the position information, that the virtual object has arrived at one control node of the one or more control nodes, obtaining a control strategy corresponding to the one control node; and
based on the control strategy, controlling the virtual object to move along the virtual movement trajectory, and controlling the virtual lens to capture the image of the virtual object moving along the virtual movement trajectory.

7. The movement trajectory playback method according to claim 6, wherein based on the control strategy, controlling the virtual object to move along the virtual movement trajectory and controlling the virtual lens to capture the image includes:
obtaining a type of the one control node; and
in response to the one control node being a normal control node:
obtaining control parameters corresponding to the one control node, the control parameters including a movement speed of the virtual object, a virtual lens angle of the virtual lens that is a pitch angle of the virtual lens, and a map scale corresponding to the virtual lens;
controlling, based on the movement speed, the virtual object to move along the virtual movement trajectory; and
controlling, based on the virtual lens angle and the map scale, the virtual lens to capture the image of the virtual object moving along the virtual movement trajectory.

8. The movement trajectory playback method according to claim 7, wherein:
the one or more control nodes include a first control node, a second control node, and a third control node each being a normal control node, and the first control node, the second control node, and the third control node divide the virtual movement trajectory into a first sub-trajectory, a second sub-trajectory, a third sub-trajectory, and a fourth sub-trajectory;
the first sub-trajectory is a trajectory between the first control node and a starting point of the virtual movement trajectory;
the second sub-trajectory is a trajectory between the first control node and the second control node;
the third sub-trajectory is a trajectory between the second control node and the third control node; and
the fourth sub-trajectory is a trajectory between the third control node and an end point of the virtual movement trajectory.

9. The movement trajectory playback method according to claim 8, wherein a ratio of trajectory lengths of the first sub-trajectory, the second sub-trajectory, the third sub-trajectory, and the fourth sub-trajectory is 2:1:2:5.

10. The movement trajectory playback method according to claim 8, wherein:
control parameters corresponding to the first control node include a first movement speed, a first virtual lens angle, and a first map scale;
control parameters corresponding to the second control node include a second movement speed, a second virtual lens angle, and a second map scale;
control parameters corresponding to the third control node include a third movement speed, a third virtual lens angle, and a third map scale;
the first movement speed is less than the second movement speed, and the second movement speed is less than the third movement speed;
the first virtual lens angle is greater than or equal to the second virtual lens angle, and the second virtual lens angle is greater than the third virtual lens angle; and
the first map scale is greater than the second map scale, and the second map scale is greater than the third map scale.

11. The movement trajectory playback method according to claim 6, wherein based on the control strategy, controlling the virtual object to move along the virtual movement trajectory and controlling the virtual lens to capture the image includes:
obtaining a type of the one control node;
in response to the one control node being a lens movement control node, determining a lens movement object corresponding to the one control node;
obtaining a lens orientation corresponding to the lens movement object; and
controlling, based on the lens orientation, the virtual lens to capture the image of the virtual object moving along the virtual movement trajectory.

12. The movement trajectory playback method according to claim 11, wherein obtaining the lens orientation includes:
in response to detecting that the lens movement object is an intersection in the three-dimensional virtual scene, determining a movement direction of the virtual object as the lens orientation.

13. The movement trajectory playback method according to claim 11, wherein obtaining the lens orientation includes:
in response to detecting that the lens movement object is a target building in the three-dimensional virtual scene, determining, in a ground coordinate system of the three-dimensional virtual scene, a direction from a position of the virtual object to a position of the target building as the lens orientation.

14. The movement trajectory playback method according to claim 11,
wherein the one or more control nodes further include a plurality of normal control nodes which divide the virtual movement trajectory into a plurality of sub-trajectories each corresponding to a reference priority;
the method further comprising, before obtaining the lens orientation:
selecting, from the plurality of sub-trajectories, one sub-trajectory where the one control node is located as a target sub-trajectory;
obtaining a reference priority corresponding to the target sub-trajectory and a priority of the lens movement object; and
comparing the priority of the lens movement object with the reference priority;
wherein obtaining the lens orientation includes obtaining the lens orientation corresponding to the lens movement object in response to the priority of the lens movement object being greater than or equal to the reference priority.

15. The movement trajectory playback method according to claim 14, wherein for each sub-trajectory of the plurality of sub-trajectories, a reference priority corresponding to the sub-trajectory is positively correlated with a distance from the sub-trajectory to a starting point of the virtual movement trajectory.

16. An electronic device comprising:
a processor; and
a memory storing a plurality of instructions that, when executed by the processor, cause the electronic device to:
obtain a three-dimensional virtual scene;
determine a real movement trajectory of a real object;
map the real movement trajectory to the three-dimensional virtual scene to obtain a virtual movement trajectory;
set, in the three-dimensional virtual scene, a virtual object corresponding to the real object and a virtual lens corresponding to the virtual object, a preset relative positional relationship between the virtual lens and the virtual object being maintained;
control the virtual object to move along the virtual movement trajectory, and control the virtual lens to capture an image of the virtual object moving along the virtual movement trajectory; and
display the image.

17. The electronic device according to claim 16, wherein the instructions, when executed by the processor, further cause the electronic device to, when controlling the virtual object to move along the virtual movement trajectory and controlling the virtual lens to capture the image:
obtain position information of the virtual object on the virtual movement trajectory; and
based on the position information, control the virtual object to move along the virtual movement trajectory, and controlling the virtual lens to capture the image of the virtual object moving along the virtual movement trajectory.

18. The electronic device according to claim 17, wherein the instructions, when executed by the processor, further cause the electronic device to, when controlling, based on the position information, the virtual object to move along the virtual movement trajectory:
determine, according to the position information, a remaining trajectory length of the virtual object, the remaining trajectory length being a length of a portion of the virtual movement trajectory that the virtual object has not traversed;
determine, according to the remaining trajectory length, a target movement speed of the virtual object, the target movement speed being negatively correlated with the remaining trajectory length; and
control, based on the target movement speed, the virtual object to move along the virtual movement trajectory.

19. The electronic device according to claim 18, wherein the instructions, when executed by the processor, further cause the electronic device to, when controlling, based on the position information, the virtual lens to capture the image includes:
determine, according to the remaining trajectory length, a target virtual lens angle of the virtual lens, the target virtual lens angle being a pitch angle of the virtual lens and being positively correlated with the remaining trajectory length; and
control, based on the target virtual lens angle, the virtual lens to capture the image of the virtual object moving along the virtual movement trajectory.

20. A non-transitory computer-readable storage medium storing a plurality of instructions stored that, when executed by a processor, cause an electronic device including the processor to:
obtain a three-dimensional virtual scene;
determine a real movement trajectory of a real object;
map the real movement trajectory to the three-dimensional virtual scene to obtain a virtual movement trajectory;
set, in the three-dimensional virtual scene, a virtual object corresponding to the real object and a virtual lens corresponding to the virtual object, a preset relative positional relationship between the virtual lens and the virtual object being maintained;
control the virtual object to move along the virtual movement trajectory, and control the virtual lens to capture an image of the virtual object moving along the virtual movement trajectory; and
display the image.
